(19) United States
(12) Patent Application Publication
(10) Pub. No.: US 2007/0267042 A1
(43) Pub. Date: Nov. 22, 2007

(54) Cleaning article

(76) Inventor: Gene Menzies, Rodeo, CA (US)

Correspondence Address: Michael E. Dergosits;Suite 1450, Four Embarcadero Center, San Francisco, CA, 94111, US

(21) Appl. No.: 11/504,913

(22) Filed: Aug. 15, 2006

Related U.S. Application Data
(60) Provisional application No. 60/802,550, filed on May 22, 2006.

(51) Int. Cl. B08B 3/12; B08B 7/00; B43L 21/00; A47K 7/02

(52) U.S. Cl. 134/6; 134/1; 15/244.1; 15/244.4

(57) ABSTRACT

A cleaning article in the form of a sponge body for absorbing and retaining a fluid and an encasement membrane attached to the sponge body. The encasement membrane covers a portion of the sponge body being sized to fit within and be held by the hand of a user while leaving exposed, a portion of the sponge body for engaging a surface to be cleaned. As a preferred embodiment, the encasement membrane is further characterized as being a thermal insulator substantially reducing thermal energy contained within the fluid from passing therethrough. The encasement membrane is also characterized as being impervious to water, steam or other gasses to prevent their escape where they could affect the user's hand. The present invention is ideally suited for cleaning a surface by applying a cleaning fluid, such as water with or without a detergent to the sponge body and placing the cleaning article within a microwave oven. The temperature of the cleaning fluid contained within the sponge body is thus raised while the encasement membrane prevents a user from being exposed to thermal energy contained within the cleaning fluid held by the sponge body.

### RELATED APPLICATIONS

Benefit is hereby made of U.S. Provisional Application No. 60/802,550, filed on May 22, 2006.

### TECHNICAL FIELD

The present invention is directed to a cleaning article and method of using the cleaning article for cleaning a surface. The cleaning article includes a sponge body for absorbing and retaining a fluid and an encasement membrane surrounding a portion of the sponge body while leaving a surface exposed for carrying out the cleaning operation. The encasement membrane acts as an insulator to substantially prevent thermal energy applied to the sponge body through, preferably, microwave irradiation from passing to the hand of a user while gripping the cleaning article for cleaning a surface, and further acts to retain thermal energy in the sponge to keep it hot longer for enhanced cleaning.

### BACKGROUND OF THE INVENTION

Sponges have been used quite extensively for cleaning surfaces as they retain water or other cleaning solutions, the amount of these cleaning solutions retained within a sponge body being dependent upon the nature of the sponge, its physical dimensions and whether the sponge has been subjected to compression. There are many varieties of sponges both natural and synthetic while artificial sponges were first developed by the Du Pont Company in the 1940's. Du Pont engineers patented the cellulose sponge process noting that in the second half of the 20^{th} century, cellulose sponges rapidly replaced the natural sponge for most common household uses.

Although sponges are widely used for cleaning applications, they are not without certain inherent limitations. Most notably, although it is well recognized that the cleaning process can be enhanced by employing cleaning fluids of higher temperatures, when a sponge is exposed to high temperature fluids, the temperature of such fluids is limited by a user's ability to tolerate the higher temperatures during the cleaning process. Unless a user was to apply a thermal insulating glove during cleaning, users are oftentimes hesitant to grab a cleaning sponge dipped in excessively hot water for fear of receiving burn injuries. However, if only cold or lukewarm cleaning fluid was to be employed, the cleaning potential in using a sponge is certainly compromised.

It is thus an object of the present invention to provide a cleaning article and method of employing it to enable a user to use cleaning fluids of significantly high temperatures while enabling a user to grip the cleaning article without the fear of burning and while obviating the need for using protective garments such as thermally insulating gloves.

These and further objects will be more readily apparent when considering the following disclosure and appended claims.

### SUMMARY OF THE INVENTION

A cleaning article in the form of a sponge body for absorbing and retaining a fluid and an encasement membrane attached to the sponge body. The encasement membrane covers a portion of the sponge body being sized to fit within and be held by the hand of a user while leaving exposed, a portion of the sponge body for engaging a surface to be cleaned. The encasement membrane is further characterized as being a thermal insulator substantially reducing thermal energy contained within the fluid from passing therethrough. As a preferred embodiment, the encasement membrane is also characterized by being impervious to water, steam or other gasses to prevent their escape where they may injure the user's hands. The present invention is ideally suited for cleaning a surface by applying a cleaning fluid, such as water with or without a detergent to the sponge body and placing the cleaning article within a microwave oven. The temperature of the cleaning fluid contained within the sponge body is thus raised while the encasement membrane prevents a user from being exposed to thermal energy contained within the cleaning fluid held by the sponge body. The encasement membrane also acts as a thermal barrier to maintain the temperature of the sponge for a longer period to enhance the cleaning function. Further, its exposure to microwave radiation acts to sterilize the sponge to provide a more antiseptic cleaning process.

### BRIEF DESCRIPTION OF THE FIGURES

FIG. 1 is a perspective view, partially cut away to show the internal construction of the cleaning article of the present invention.

FIG. 2 is a schematic illustration of a method of using the cleaning article of FIG. 1 and preparing the article for use and in cleaning an appropriate surface.

### DETAILED DESCRIPTION OF THE INVENTION

The present invention is directed to cleaning article 10 which comprises sponge body 12. Sponge body 12, as noted previously, can be a natural or synthetic sponge having intersities capable of absorbing and selectively retaining a cleaning fluid, such as water, with or without a detergent. Encasement membrane 11 covers a portion of sponge 12 being sized to fit within and be held by the hand of a user while leaving exposed portion 13 of sponge body 12 for engaging a surface to be cleaned. Encasement membrane 11 is characterized as being a thermal insulator substantially preventing thermal energy contained within the cleaning fluid from passing therethrough.

Cleaning article 10 is shown as having sponge body 12 for absorbing and retaining a fluid (not shown) and an encasement membrane 11 attached thereto. The encasement membrane 11 covers a portion of sponge body 12 being sized to fit within and be held by the human hand of a user leaving exposed portion 13 of sponge body 12 for engaging a surface to be cleaned. Ericasement membrane 11 is further characterized as being a thermal insulator substantially preventing thermal energy contained within the fluid retained within sponge body 12 from passing therethrough. As a preferred embodiment, the encasement membrane 11 is also characterized by being impervious to water, steam or other gasses to prevent those from contacting the user's hand.

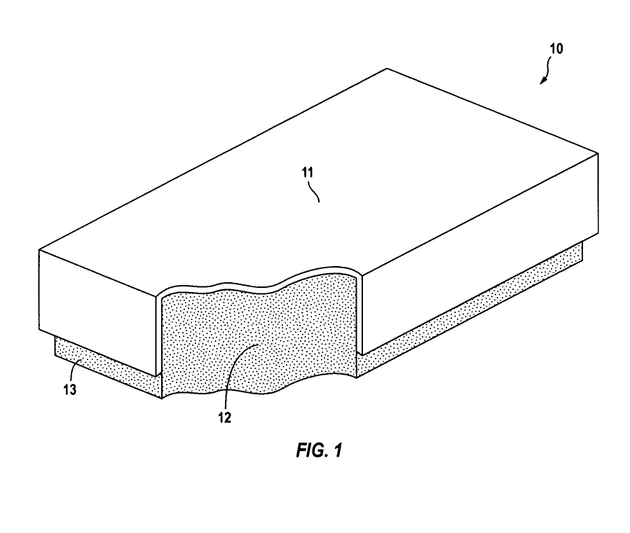

Cleaning article 10 is shown as being rectangular in FIG. 1 having two substantially parallel surfaces, the first being at 13 and the second fully encased within encasement membrane 11 and being connected by perpendicular sidewalls. As such, encasement membrane 11 substantially encases one of the parallel surfaces and perpendicular sidewalls exposing the second parallel surface 13 as a cleaning surface.

Although the physical embodiment of FIG. 1 is of a rectangular shape, virtually any geometric shape can be employed in practicing the present invention. All that is important in configuring the present invention properly is to provide an encasement membrane which can conveniently be held by the hand of a user when employing cleaning article 10 for its intended purpose and which enables at least a portion of sponge body 12 to be exposed, again, to carry out the cleaning function.

It is a cornerstone in practicing the present invention to provide encasement membrane 11 of a suitable thickness and material to sufficiently insulate the hand of a user when fluid contained within sponge body 12 becomes very hot, such as by wetting sponge body 12 with a suitable cleaning solution and placing cleaning article 10 within a microwave irradiation source to significantly raise the temperature of this fluid. By illustration, it is suggested that a suitable encasement membrane be a closed cell foam of, for example, ⅛″ in thickness. An example of a suitable foam is available from Stephenson & Lawyer, Inc., sold under the trade name Volara™.

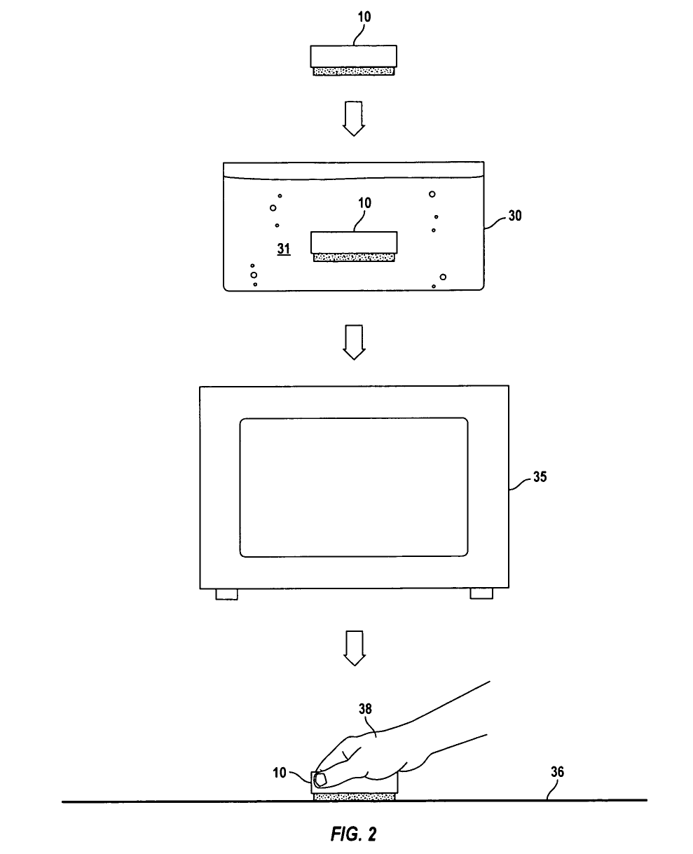

In employing cleaning article 10, reference is made to FIG. 2. As noted, cleaning article 10 is first subjected to a cleaning fluid such as water containing a surfactant 31 maintained within bucket or tub 30 although the sponge can be wet by other means such as by holding it under a faucet of running water. Once sufficient liquid has been retained within the intersities of sponge body 12, cleaning article 10 can then be placed within microwave irradiation source 35 and heated until the cleaning fluid contained within sponge body 12 gets to the point of near boiling. Ordinarily, without encasement membrane 11, sponge body 12 would be too hot to handle without protective means such as a glove making microwave irradiation of a typical sponge unworkable even though it is well recognized that high temperatures clearly enhance the effectiveness of the cleaning operation. By employing encasement membrane 11, hand 38 of a user can grasp cleaning article 10 without discomfort or injury. And, as noted previously, elevated temperatures of the cleaning fluid contained within sponge body 12 would enhance the effectiveness of the cleaning article when employed for its intended purpose. By employing microwave irradiation coupled with the described encasement membrane, a user will be able to heat the cleaning article to much higher temperatures than would normally be the case. Microwave energy also disinfects the sponge to provide a more antiseptic cleaning process. No longer is it required that the sponge be dipped in a hot cleaning solution. Instead, the cleaning solution could be at virtually any temperature whereupon the cleaning article be placed in a microwave irradiation source and heated to the desired temperature and because of the encasement membrane, this temperature can be significantly higher than was previously thought to be practical. This will also help to reduce bacteria and other foreign bodies which would otherwise remain within the intersities of the sponge body resulting in surface contamination.

It should further be noted that encasement membrane 11 can be physically adhered to sponge body 12 by any convenient means including gluing, heat bonding, friction fit, hook and loop fasteners or lamination. It may also be desirable to allow sponge body 12 to be removable from encasement membrane 11 to allow a user to reemploy the encasement membrane as sponges wear out over time. Thickness of encasement membrane 11 could vary widely noting that a typical closed cell foam of ⅛″ in thickness appears to work well in practicing the present invention. Thickness and material choices should be governed by enabling a user to handle the present cleaning article comfortably although sponge body 12 may contain cleaning fluid at boiling temperatures. The encasement membrane 11 should also be made of non-liquid absorbent materials, of which closed cell foam is an example, to prevent liquid from intruding therein and causing its temperature to rise as influenced by microwave irradiation. Finally, as a preferred embodiment, the encasement membrane 11 should be impervious to water, steam or gasses to prevent such hot liquids or gasses from penetrating the membrane and thereby contacting the user's hand when the cleaning article 10 is utilized.

1. A cleaning article comprising a sponge body for absorbing and retaining a fluid and an encasement membrane attached to said sponge body, said encasement membrane covering a portion of said sponge body being sized to fit within and be held by the hand of a user and leaving exposed, a portion of said sponge body for engaging a surface to be cleaned, said encasement membrane being further characterized as being a thermal insulator substantially reducing significant thermal energy contained within said fluid from passing therethrough.

2. The cleaning article of claim 1 wherein said sponge is substantially rectangularly-shaped having two substantially parallel surfaces connected by substantially perpendicular sidewalls, said membrane substantially encasing one of said parallel surfaces and perpendicular sidewalls exposing the second of said parallel surfaces as a cleaning surface.

3. The cleaning article of claim 1 wherein said encasement membrane comprises a material whose temperature does not significantly increase upon exposure to microwave irradiation.

4. The cleaning article of claim 1 wherein said encasement membrane comprises a material which is impervious to water, steam or other gasses.

5. The cleaning article of claim 3 wherein said encasement membrane comprises a closed cell foam.

6. A method of cleaning a surface, said method comprising providing a cleaning article, said cleaning article comprising a sponge body for absorbing and retaining a fluid and an encasement membrane attached to said sponge body, said encasement membrane covering a portion of said sponge body being sized to fit within and be held by the hand of a user and leaving exposed, a portion of said sponge body for engaging a surface to be cleaned, said encasement membrane being further characterized as being a thermal insulator substantially reducing significant thermal energy contained within said fluid from passing therethrough, applying said cleaning fluid to said sponge body, subjecting said cleaning article to microwave irradiation to raise the temperature of said fluid, gripping said cleaning article by said encasement membrane and applying said exposed portion of said sponge to said surface to be cleaned.

7. The method of claim 6 wherein said encasement membrane comprises a material whose temperature does not significantly increase upon exposure to microwave irradiation.

8. The method of claim 7 wherein said encasement membrane comprises a closed cell foam.

9. The method of claim 6 wherein said cleaning fluid comprises water.
